(19) United States
(12) Patent Application Publication
(10) Pub. No.: US 2010/0199060 A1
(43) Pub. Date: Aug. 5, 2010

(54) MEMORY CONTROLLER, NONVOLATILE MEMORY MODULE, ACCESS MODULE, AND NONVOLATILE MEMORY SYSTEM

(75) Inventors: Masahiro NAKANISHI, Kyoto (JP); Tatsuya ADACHI, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/365,556

(22) Filed: Feb. 4, 2009

(51) Int. Cl. G06F 12/00; G06F 12/02

(52) U.S. Cl. 711/173; 711/E12.001; 711/E12.002; 711/154; 711/103

(57) ABSTRACT

An address management part 125 manages a nonvolatile memory 110 by dividing the memory into a region 110A and a region 110B. When recording plural pieces of contents as in a normal recording, a reading-writing controller 107 writes data to the region 110A in an alternate manner. Furthermore, when recording a piece of content (a presently watched TV program) in a FIFO manner as in a continuous recording, the reading-writing controller 107 writes data to the region 110B in a circular manner. In this manner, lives of a nonvolatile memory module, a memory controller of the nonvolatile memory module, and a whole nonvolatile memory system including an access module can be extended than ever.

### BACKGROUND OF THE INVENTION

1. Field of the invention

The present invention relates to a memory controller for controlling the data reading and writing from and to a nonvolatile memory, a nonvolatile memory module such as a semiconductor memory card having the nonvolatile memory and the memory controller, an access module for ordering the nonvolatile memory module to read and write data, and a nonvolatile memory system including the nonvolatile memory module and the access module as a component.

2. Discussion of the Related Art

A nonvolatile memory module having a rewritable nonvolatile memory is increasingly demanded as a detachable memory device mainly for a semiconductor memory card. The semiconductor memory card is very high-price compared to an optical disk, media of tape, and the like, however, the semiconductor memory card is increasingly demanded as a memory medium for a portable apparatus such as a digital still camera and a personal computer because having merits such as small-size, lightweight, vibration resistance, and easy handling. In these years, consideration of an application of the semiconductor memory card for a substitute device of a hard disk in a personal computer and for a recording medium in a portable apparatus is also progressing with enlargement of a size of the semiconductor memory card.

This semiconductor memory card includes a flash memory as a nonvolatile main memory, and includes a memory controller for controlling it. The memory controller controls the data reading and writing from and to the flash memory in accordance with reading and writing commands from the access module, for example, the digital still camera or the personal computer. In addition, some digital still camera or portable audio apparatus includes a semiconductor memory card as a non-detachable nonvolatile memory module.

Since requiring relatively-long time to write and erase data to a memory cell array that is a storage unit, the flash memory is configured so as to collectively write and erase data to a plurality of the memory cells. Specifically, the flash memory is composed of a plurality of physical blocks, and each physical block includes a plurality of pages. The above-mentioned flash memory erases data in units of physical blocks and writes data in units of pages.

In these years, to satisfy demands for a high capacity and a low cost, a main type of the flash memory is able to store 2-bit data in one memory cell such as a multi-level NAND flash memory. Such multi-level NAND flash memory is hard to ensure reliability of the memory cell, and thus the possible number of data rewritings is small. A conventional single-level NAND flash memory ensures 100,000 rewritings and 10-year data retention. On the other hand, the multi-level NAND flash memory can ensure no more than 10,000 rewritings. In addition, the number of rewritings and the time of data retention have a trade-off relationship shown, for example, in FIG. 1, and the time of data retention accordingly decreases with increase of the number of data rewritings. In this manner, the number of rewritings and the time of data retention are directly linked to a life of the nonvolatile memory module such as the semiconductor memory card and a life of a nonvolatile memory system having the nonvolatile memory module.

An address management method called a wear leveling that prevents a certain physical block from being intensively rewritten is conventionally employed to extend a life of the memory cell as long as possible. According to Japanese Unexamined Patent Publication No. 2003-263894, data is written to an empty physical block that is an empty region in the data writing. On this occasion, when old data related to a logical address addressed in the writing is stored, old data in a physical block storing the related old data is erased and further the physical block is managed as an empty block. In this manner, it is tried to prevent a certain physical block from being intensively written.

In addition, according to Japanese Unexamined Patent Publication No. H5-282880, it is tried to manage the number of rewritings in units of physical blocks and to level the number of rewritings by writing data to a physical block with small number of rewritings prior to other physical blocks.

### SUMMARY OF THE INVENTION

For example, when a memory card is used for recording a TV program, there are two purposes of the recording. One is the recording intended to store the TV program to the memory card and to watch the stored TV program at any time after the TV program ended. The recording for this purpose is referred to as a normal recording. The other is the recording intended to watch the on-air TV program by tracking the program back for a certain time, for example, 10 minutes or 30 minutes, from the present time, namely, to watch the program late for the a broadcast time. It is called a rewind reproduction to reproduce the on-air TV program by tracking the program back for a certain time with recording the on-air TV program, and the recording for this rewind reproduction is referred to as a continuous recording. In the continuous recording, a memory card has a limited capacity, the data is continuously recorded with securing an empty region by erasing old data. The number of data rewritings extraordinary increases because of this repetition of the data erasing, resulting in rapid deterioration of memory cell. When one semiconductor memory card is used for both of the normal recording and the continuous recording, a problem of a rapidly shortening retention time of data recorded in the normal recording arises due to an influence of the deterioration of memory cell caused by the continuous recording. The above-mentioned deterioration of memory cell is referred to as an interference deterioration.

A certain multi-value flash memory was used under following conditions, and the interference deterioration was examined after 10 years passed.

### <Use Conditions>

The normal recording time is 2 hours a day.

The continuous recording time (a watching time) is 10 hours a day.

A recording rate is 8.5 Mbps.

A rewind reproduction time is 1 hour.

FIG. 2A shows periods in a case of the normal recording for which data can be retained when only the normal recording of 2 hours a day is carried out among the above-mentioned use conditions. FIG. 2B shows periods in cases of the normal recording and the continuous recording for which data can be retained when the normal recording of 2 hours a day and the continuous recording of 10 hours a day are carried out in accordance with the above-mentioned use conditions. Numeral values in parentheses of FIG. 2A and FIG. 2B show the number of rewritings after 10 years. For example, comparing the cases of a memory card with 32 GB size each other, the data retention time in FIG. 2A is 220 days, while the time in FIG. 2B is 5 days. The data retention time is extraordinary shortened to be approximately one-fortieth only by increasing a recording time a day from the normal recording of 2 hours to 12 hours including the continuous recording, namely making six times as great. This shows a case where the memory card cannot be used to watch a TV program on weekend, the TV program being recorded, for example, on Monday by a programmed recording (the normal recording).

In view of the aforementioned problems, the present invention in tends to provide a memory controller, a nonvolatile memory module, an access module, and a nonvolatile memory system which can extend a whole life of the nonvolatile memory system than ever even when data are recorded by a plurality of different recording modes, for example, the normal recording and the continuous recording.

To solve the problems, a memory controller according to the present invention which is connected to a nonvolatile memory, and writes a first type of data required to be retained for long time and a second type of data not required to be retained for the long time and reads the written data in accordance with an access command from an outside, comprises: an address management part for managing said nonvolatile memory by dividing the nonvolatile memory into a first region to which said first type of data is written and a second region to which second type of data is written; and a reading-writing controller for writing only said first type of data to said first region in an alternate manner and writing only said second type of data to said second region in a circular manner.

The memory controller may further comprise: a recording mode switch for determining a recording mode in accordance with recording mode identification information addressed by an outside, wherein said reading-writing controller judges whether data to be written to said nonvolatile memory is said first type of data or said second type of data in accordance with the recording mode determined by said recording mode switch.

Said recording mode identification information may be configured by at least one of an address and a flag of a logical block to which data is written.

The memory controller may further comprise: a recording region size setting part for determining a size of said second region on the basis of one of maximum rewind time information preliminarily set and addressed from an outside.

The memory controller may further comprise: a life determination part for calculating at least data retention time of data stored in said second region, and for outputting warning information to an outside at one of timings when the data retention time falls below reproduction time corresponding to said maximum rewind time information and when the falling can be predicted.

To solve the problems, a nonvolatile memory module according to the present invention which reads and writes data in accordance with an access command from an outside, comprises: a nonvolatile memory; and a memory controller which is connected to a nonvolatile memory, and writes a first type of data required to be retained for long time and a second type of data not required to be retained for the long time and reads the written data in accordance with an access command from an outside, wherein said memory controller includes: an address management part for managing said nonvolatile memory by dividing the nonvolatile memory into a first region to which said first type of data is written and a second region to which second type of data is written; and a reading-writing controller for writing only said first type of data to said first region in an alternate manner and writing only said second type of data to said second region in a circular manner.

Said memory controller may further comprise: a recording mode switch for determining a recording mode in accordance with recording mode identification information addressed by an outside, wherein said reading-writing controller judges whether data to be written to said nonvolatile memory is said first type of data or said second type of data in accordance with the recording mode determined by said recording mode switch.

Said recording mode identification information may be configured by at least one of an address and a flag of a logical block to which data is written.

Said memory controller may further comprise: a recording region size setting part for determining a size of said second region on the basis of one of maximum rewind time information preliminarily set and addressed from an outside.

Said memory controller may further comprise: a life determination part for calculating at least data retention time of data stored in said second region, and for outputting warning information to an outside at one of timings when the data retention time falls below reproduction time corresponding to said maximum rewind time information and when the falling can be predicted.

To solve the problem, an access module according to the present invention connected to the nonvolatile memory module according to claim 7 to read and write data, comprises: a recording mode notification part for notifying said nonvolatile memory module of said recording mode.

To solve the problem, an access module according to the present invention connected to the nonvolatile memory module according to claim 9 to read and write data, comprises: a recording mode notification part for notifying said nonvolatile memory module of said maximum rewind time information.

To solve the problem, an access module according to the present invention connected to the nonvolatile memory module according to claim 10 to read and write data, comprises: a warning information display for displaying said warning information received from said nonvolatile memory module.

To solve the problem, a nonvolatile memory system according to the present invention comprises: an access module; and a nonvolatile memory module for reading and writing data in accordance with an access command from said access module, wherein: said nonvolatile memory module includes: a nonvolatile memory; and a memory controller which is connected to a nonvolatile memory, and writes a first type of data required to be retained for long time and a second type of data not required to be retained for the long time and reads the written data in accordance with an access command from said access module; and said memory controller includes: an address management part for managing said nonvolatile memory by dividing the nonvolatile memory into a first region to which said first type of data is written and a second region to which second type of data is written; and a reading-writing controller for writing only said first type of data to said first region in an alternate manner and writing only said second type of data to said second region in a circular manner.

Said memory controller may further comprise: a recording mode switch for determining a recording mode in accordance with recording mode identification information addressed by said access module, wherein said reading-writing controller judges whether data to be written to said nonvolatile memory is said first type of data or said second type of data in accordance with the recording mode determined by said recording mode switch.

Said recording mode identification information may be configured by at least one of an address and a flag of a logical block to which data is written.

Said memory controller may further comprise: a recording region size setting part for determining a size of said second region on the basis of one of maximum rewind time information preliminarily set and addressed from said access module.

Said memory controller may further comprise: a life determination part for calculating at least data retention time of data stored in said second region, and for outputting warning information to said access module at one of timings when the data retention time falls below reproduction time corresponding to said maximum rewind time information and when the falling can be predicted.

According to the present invention, the address management part of the memory controller manages the nonvolatile memory by dividing the memory into two regions, the first region and the second region. The reading-writing controller writes data to the first region in a case of storing a plurality of contents as the normal recording, and writes data to the second region in a circular manner in a case of recording a piece of content in a first-in first-out manner as the continuous recording. Since this can avoid the interference deterioration in the first region caused by the continuous recording, a life of the nonvolatile memory module can be extended than ever. In addition, a whole life of the nonvolatile memory system including the nonvolatile memory module, the memory controller of the nonvolatile memory module, and the access module can be extended than ever.

### BRIEF DESCRIPTION OF THE DRAWINGS

FIG. 1 is a view showing a graph of reliability of a multi-level flash memory;

FIG. 2A is a view showing data retention time of a case where only a normal recording is carried out in a conventional nonvolatile memory system;

FIG. 2B is a view showing data retention time of a case where both of the normal recording and a continuous recording are carried out in a conventional nonvolatile memory system;

FIG. 3 is a block diagram showing a nonvolatile memory system in an embodiment of the present invention;

FIG. 4 is a view showing a memory map of a nonvolatile memory 110;

FIG. 5 is a view showing a physical region management table 131;

FIG. 6 is a view showing a logical-physical conversion table 132;

FIG. 7 is a view showing a life table 129a;

FIG. 8 is a flowchart showing overall processing of a nonvolatile memory module 100 in the embodiment of the present invention;

FIG. 9 is a flowchart showing processing for setting a recording region size;

FIG. 10 is a view showing a time chart in writing processing;

FIG. 11 is a flowchart showing the writing processing in an alternate manner;

FIG. 12A is an explanation view showing a recording state before the writing in the alternate manner;

FIG. 12B is an explanation view showing a recording state after the writing in the alternate manner;

FIG. 13 is a view showing the physical region management table 131 at the time of writing in the alternate manner;

FIG. 14 is a view showing the logical-physical conversion table 132.at the time of writing in the alternate manner;

FIG. 15 is a flowchart showing writing processing in a circular manner;

FIG. 16A is an explanation view showing a recording state before the writing in the circular manner;

FIG. 16B is an explanation view showing a recording state after the writing in the circular manner;

FIG. 17 is a view showing the physical region management table 131 at the time of writing in the circular manner;

FIG. 18 is a view showing the logical-physical conversion table 132 at the time of writing in the circular manner;

FIG. 19 is a flowchart showing life judgment processing; and

FIG. 20 is a view showing data retention time of a case where both of the normal recording and the continuous recording are carried out in the nonvolatile memory system according to the embodiment of the present invention.

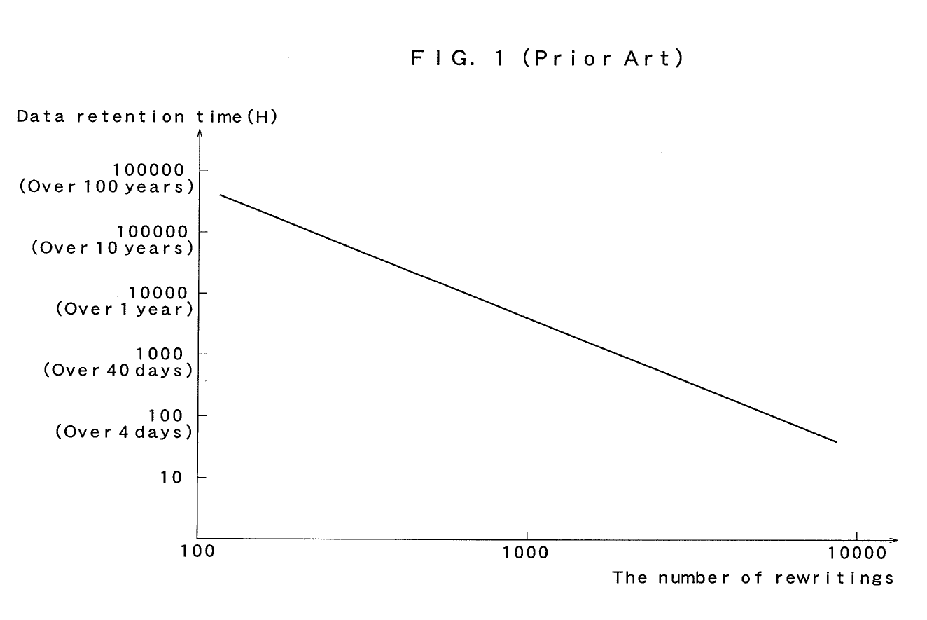

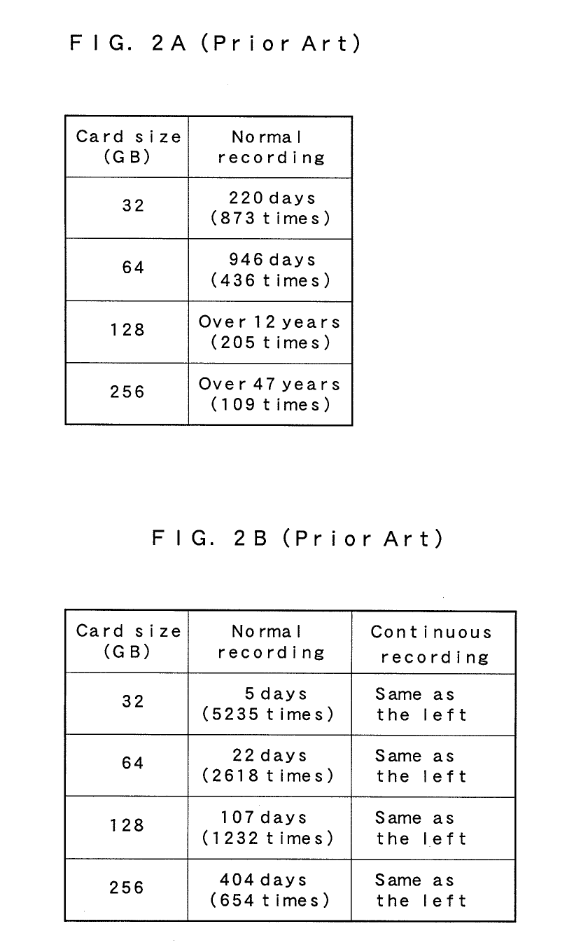

### DESCRIPTION OF THE PREFERRED EMBODIMENTS

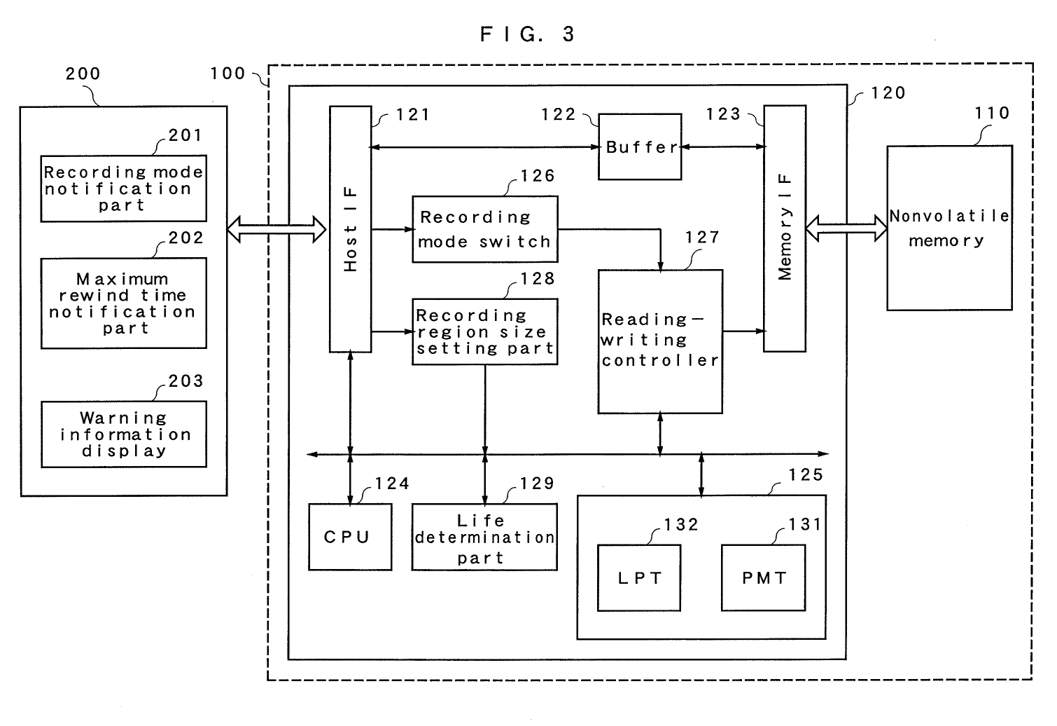

Using drawings, an embodiment of the present invention will be described below. FIG. 3 is a block diagram showing a nonvolatile memory system according to the embodiment of the present invention. The nonvolatile memory system includes a nonvolatile memory module 100 and an access module 200, and the nonvolatile memory module 100 and the access module 200 are connected each other via an external bus.

The nonvolatile memory module 100 includes a nonvolatile memory 110 and a memory controller 120, and writes data to the nonvolatile memory 110 and reads data from the nonvolatile memory 110 in accordance with a command from the access module 200. The nonvolatile memory 110 and the memory controller 120 are connected each other via a memory bus.

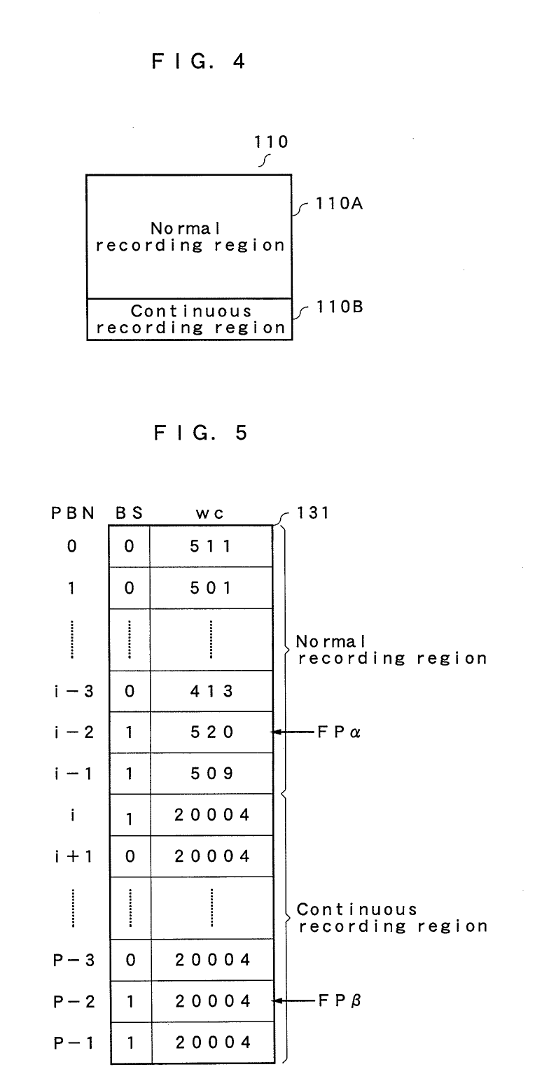

The nonvolatile memory 110 is a flash memory, and has, for example, P physical blocks (P is a natural number). Each physical block includes a plurality of pages, data is written in units of pages, and data is erased in units of physical blocks. As shown in FIG. 4, the nonvolatile memory 110 has a region 110A that is a first region used for the normal recording. The nonvolatile memory 110 further has a region 110B that is a second region user for the continuous recording. The region 110A and the region 110B are provided by physically dividing the nonvolatile memory 110. All of the P physical blocks are used for data recording, and a size of the physical block is, for example, 1 Mbytes in the embodiment.

The memory controller 120 includes a host interface (host IF) 121, a buffer 122, a memory interface (memory IF) 123, a CPU part 124, an address management part 125, a recording mode switch 126 a reading-writing controller 127, a recording region size setting part 128, and a life determination part 129.

The host interface 121 is connected to the access module 200 via the external bus. The host interface 121 receives data and a command and logical address related to data writing or reading from the access module 200, and sends read data to the access module 200 in the data reading.

The buffer 122 temporarily stores data inputted from the host interface 121 and outputs the stored data to the memory interface 123, and, conversely, temporarily stores data inputted from the memory interface 123 and outputs the stored data to the host interface 121.

The memory interface 123 is connected to the nonvolatile memory 110 via the memory bus. The memory interface 123 writes data stored by the buffer 122 to the nonvolatile memory 110, and reads data recorded to the nonvolatile memory 110 and outputs the read data to the buffer 122.

The CPU part 124 controls the whole memory controller 120.

The address management part 125 retains a physical region management table (PMT) 131 and a logical-physical conversion table (LPT) 132 in an internally provided RAM, and generates a physical address in the nonvolatile memory 110 in accordance with a command from the reading-writing controller 127 on the basis of a logical address received from the access module 200.

In the description of the embodiment, a physical block is referred to as PB, a logical block is referred to as LB, a physical block number is referred to as PBN, and a logical block number is referred to as LBN. A physical block whose physical block number PBN is, for example, 0 is referred to as PB0, and a logical block whose logical block number LBN is, for example, 0 is referred to as LB0.

FIG. 5 is a memory map showing the physical region management table 131. The physical region management table 131 retains a block status BS and the number of rewritings wc of each of the physical blocks PB0 to PB(P-1). In addition, the physical region management table 131 has an empty pointer FPα and a circular pointer FPβ. The empty pointer FPα indicates an empty physical block in the normal recording region, and the circular pointer FPβ indicates an empty physical block in the continuous recording region. In the block status BS, a value “0” indicates a used block, a value “1” indicates an empty block, and a value “2” indicates a bad block. To simplify the description, the value “2”, namely, the bad block is not included in the embodiment. In the physical blocks PB0 to PB(P-1), the physical blocks PB0 to PB(i-1) constitute the region 110A and the physical blocks PBi to PB(P-1) constitute the region 110B. The value “i” is determined depending on a size of the region 110B.

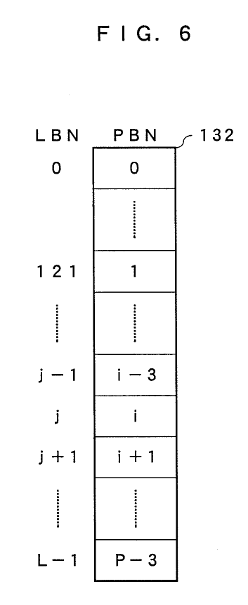

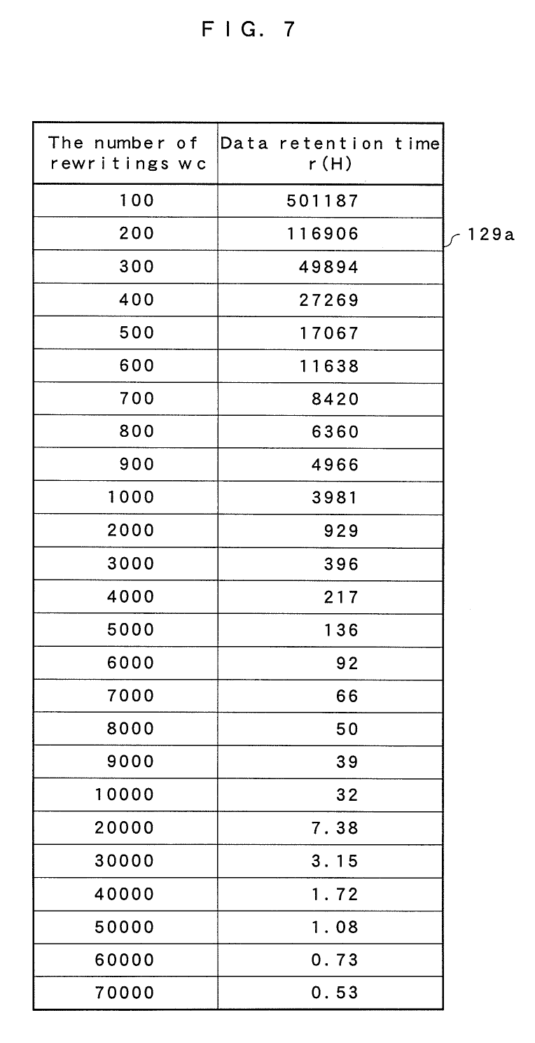

FIG. 6 is a memory map showing the logical-physical conversion table 132. The conversion table retains the physical block number PBN corresponding to the logical block number LBN. The logical block numbers LBN0 to LBN(J-1) correspond to the region 110A, and the j logical blocks LB0 to LB(j-1) are recorded to the region 110A. Additionally, the logical block numbers LBNJ to LBN(L-1) correspond to the region 110B, and the L-j logical blocks LBj to LB(L-1) are recorded to the region 110B. As a matter of convenience for the data writing, each of the region 110A and the region 110B includes two spare physical blocks. In addition, since the region 110A includes one physical block used for managing a file system, a relationship between the number of logical blocks and the number of physical blocks is shown by following expression (1) and expression (2);

i−j=3 (1),

(P−1)−(L−j)=2 (2).

A relationship between the logical block and the physical block will be explained. A logical space available by the access module 200 is composed of L logical blocks (L is a natural number). The number L of logical blocks is smaller than the number P of physical blocks, and (P-L) physical blocks are used for a spare region and a management region. The spare region is used for a work region in data rewriting or for an alternate region of a bad block that is an unusable physical block. The management region stores the physical region management table 131 and the logical-physical conversion table 132.

The recording mode switch 126 switches a recording mode on the basis of a recording mode identification flag received from the access module 200. The recording mode includes two types of modes, a normal recording mode and a continuous recording mode. A value of the recording mode identification flag is 0 in the normal recording mode and is 1 in the continuous recording mode.

The normal recording mode is a mode for writing a first type of data sent from the access module to the region 110A with searching an empty physical block in the order of the sending, and is referred to as “writing in an alternate manner”.

Meanwhile, the continuous recording mode is a mode for erasing a physical block storing earliest data and writing new data to the erased physical block when a second type of data is recorded to a physical block of the region 110B. According to this, the physical blocks of the region 110B are repeatedly used in a certain circular order. This is referred to as “writing in a circular manner”. The continuous recording mode enables the first-in first-out (FIFO) operation for reading and reproducing already written data by tracking the data back for a certain time with continuing the data writing to the region 110B, for example, the TV recording for the rewind reproduction.

The reading-writing controller 127 orders the memory interface 123 to write data in accordance with the recording mode determined by the recording mode switch 126, and orders the memory interface 123 to read data.

The recording region size setting part 128 determines a size of the region 110B used in the continuous recording mode on the basis of maximum rewind time information received from the access module 200. The maximum rewind time means an upper limit of reproduction time that can be tracked back when the content recorded in the continuous mode is reproduced. The size of the region 110B has to be equal to a size of data of the maximum rewind time or more.

The life determination part 129 retains a life table 129a shown in FIG. 7 in an internal ROM. The life table 129a shows data retention time r related to the number of rewritings wc of the nonvolatile memory 110. For example, the life table 129a shows that the data retention time r is 17,067 hours when the number of rewritings wc is 500 and that the data retention time r is 50 hours when the number of rewritings wc is 8,000. When receiving a life request command from the access module 200, the life determination part 129 judges a life of the nonvolatile memory module 100 on the basis of the data retention time r with referring to the physical region management table 131 and the life table 129a, and notify the access module 200 of a warning of the life.

The access module 200 includes a recording mode notification part 201, a maximum rewind time notification part 202, and a warning information display 203, and orders the nonvolatile module 100 to write and read data and sends the life request command to the nonvolatile module.

The recording mode notification part 201 generates a recording mode identification flag, and outputs the generated recording mode identification flag to the nonvolatile module 100.

The maximum rewind time notification part 202 generates maximum rewind time information, and outputs the generated maximum rewind time information to the nonvolatile module 100.

The warning information display 203 receives a notification of warning information from the nonvolatile memory module 100 and displays the information.

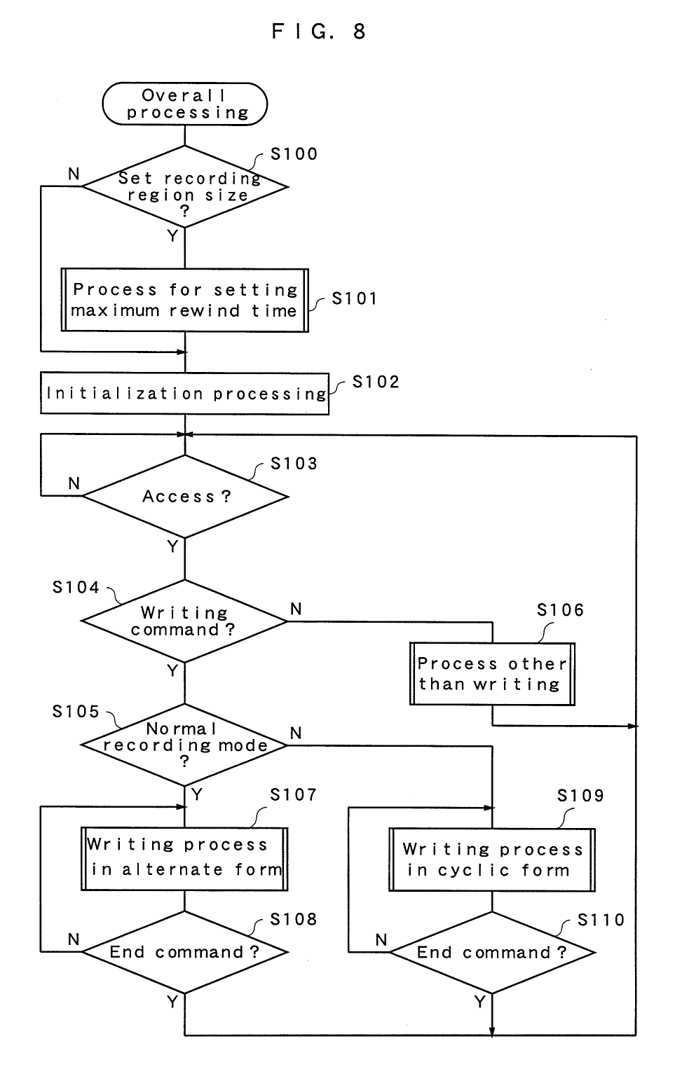

Referring to FIG. 8, an operation of the nonvolatile memory system in the embodiment configured as described above will be explained. FIG. 8 is a flowchart showing overall processing of the nonvolatile memory system in the embodiment.

At first, when the nonvolatile memory module 100 is attached to the access module 200, a power is supplied from the access module 200 to the nonvolatile memory module 100. Then, the recording region size setting part 128 judges whether or not the maximum rewind time has to be set. In a case where the maximum rewind time is not set to the nonvolatile memory module 100 or a case where an already-set maximum rewind time of the nonvolatile memory module 100 is changed, the recording region size setting part 128 determines that the maximum rewind time has to be set (S100), and the recording region size setting part 128 sets the maximum rewind time (S101). When it is determined at S100 that the maximum rewind time has not to be set and when the processing for setting the maximum rewind time is completed at S101, initialization processing of the nonvolatile memory module 100 is carried out (S102).

In the initialization processing, the memory controller 120 reads the physical region management table 131 and the logical-physical conversion table 132 retained in the management region of the nonvolatile memory 110 into a RAM included in the address management part 125. At this point, the physical region management table 131 retains information shown in FIG. 5, and the logical-physical conversion table 132 retains information shown in FIG. 6.

After the initialization processing, the nonvolatile memory module 100 waits for an access from the access module 200 (S103). When receiving the access, the CPU part 124 analyzes a command sent from the access module 200, and judges whether or not the command is a writing command (S104). When the command is the writing command, the CPU part 124 judges on the basis of the recording mode identification flag whether the mode is the normal recording mode or not (S105). When judging the command is not a writing command at S104, processing other than the writing is carried out in accordance with the command (S106). Meanwhile, the command other than the writing command is, for example, a reading command or life request command described later.

When the CPU part 124 determines at S105 that the recording mode identification flag indicates the normal recording mode, the reading-writing controller 127 carries out the writing processing in the alternate manner in units of logical blocks (S107). In each completion of the writing of one logical block, the CPU part 124 judges whether next data received from the access module 200 is an end command or data of one logical block (S108). In case of the end command, returning to S103, the nonvolatile memory module 100 waits an access from the access module 200. In case of one logical block data, returning to S107, the nonvolatile memory module 100 writes the received next data of one logical block in the alternate manner.

When the CPU part 124 determines at S105 that the recording mode identification flag indicates the continuous recording mode, the nonvolatile memory module 100 carries out the writing processing in the circular manner in units of logical blocks (S109). In each writing completion of one logical block, the CPU part 124 judges whether next data received from the access module 200 is an end command or one logical block data (S110). In case of the end command, returning to S103, the nonvolatile memory module 100 waits an access from the access module 200. In case of one logical block data, returning to S109, the nonvolatile memory module 100 writes the received next data of one logical block in the circulate manner. The above description is an explanation of overall processing of the nonvolatile memory system in the embodiment.

### [Setting of the Maximum Rewind Time (Processing for Setting a Recording Region Size)]

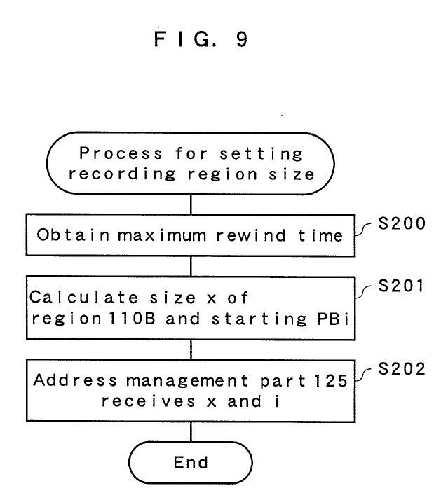

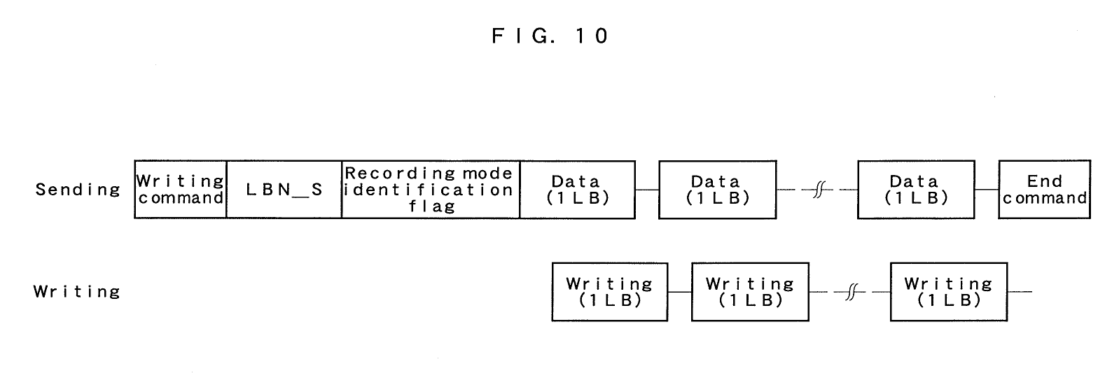

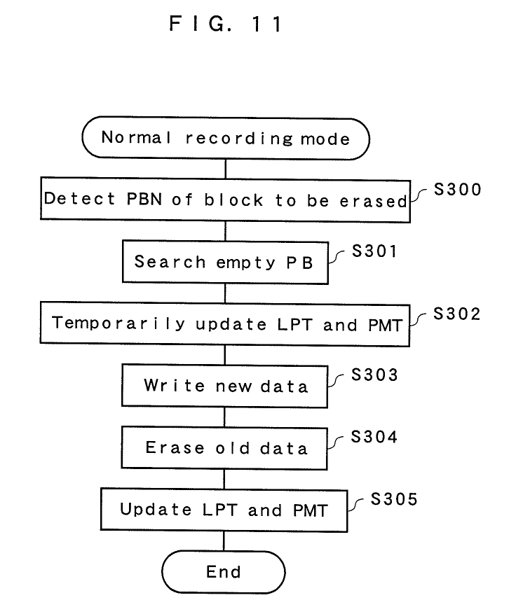

Referring to FIG. 9, the processing for setting the maximum rewind time at S101 will be explained. When the access module 200 notifies the nonvolatile memory module 100 of the maximum rewind time, the nonvolatile memory module 100 calculates the size of the region 110B on the basis of the notified maximum rewind time and divides the nonvolatile memory 110 into the region 110A for the normal recording and the region 110B for the continuous recording. As described above, the setting of the maximum rewind time is equivalent to the setting of respective sizes of the region 110A and region 110B.

FIG. 9 is a flowchart showing the processing for setting the recording region size based on the maximum rewind time. The maximum rewind time notification part 202 notifies the memory controller 120 of the maximum rewind time Tr in accordance with a command for indicating the maximum rewind time. The CPU part 124 that received this command orders the recording region size setting part 128 to carry out the processing for setting the recording region size shown in FIG. 9.

The recording region size setting part 128 that received the order obtains the maximum rewind time Tr (S200). Then, the recording region size setting part 128 calculates a size×(the number of physical blocks) of the region 110B for the normal recording by using a following expression (3);

x=(Tr×(Rw/8 bits))/PBs (3)

where the Rw is a recording rate (bps) and the PBs is a size of one physical block. When the number of spare physical blocks of the region 110B is 2, a starting physical block PBi of the region 110B is calculated with using the size x and total number P of physical blocks of the nonvolatile memory 110 by expression (4) (S201);

i=P−(x+2) (4).

For example, when the size of the nonvolatile memory 110 is 32 Gbytes (B) and the size PBs of one physical block is 1 Mbytes (B), the total number P of physical blocks is 32,768. When the recording rate Rw is 8.5 Mbps and the maximum rewind time Tr is 1 hour(H), the number x of physical blocks is 3,825 obtained by expression (3) and the size of the region 110B is a little less than 4 Gbytes. In addition, the starting physical block PBi is calculated to be 28,942 with using the number x and the total number P of physical blocks by expression (4). For reference's sake, the region 110B shares a proportion of approximately one-eighth to the size of nonvolatile memory 110.

Subsequently, the address management part 125 receives the starting physical block PBi and the number x of physical blocks calculated by the recording region size setting part 128 in this manner (S202). Thus, the address management part 125 manages the nonvolatile memory in the physical region management table 131 so that physical blocks with smaller number than the physical block PBi belong to the region 110A and physical blocks with the number PBi or more belong to the region 110B. After the above-mentioned processing, the processing for setting the maximum rewind time carried out at S101 in FIG. 8 is completed.

Meanwhile, the maximum rewind time Tr may be normally a fixed value (for example, 1 hour). When the time Tr is preliminarily stored to a ROM in the memory controller 120 or to the nonvolatile memory 110 to be referred, operations for setting the same maximum rewind time Tr many times can be omitted. In addition, the maximum rewind time Tr does not need to be the maximum rewind time itself, and can be a parameter corresponding to the maximum rewind time.

### [Recording in the Normal Recording Mode]

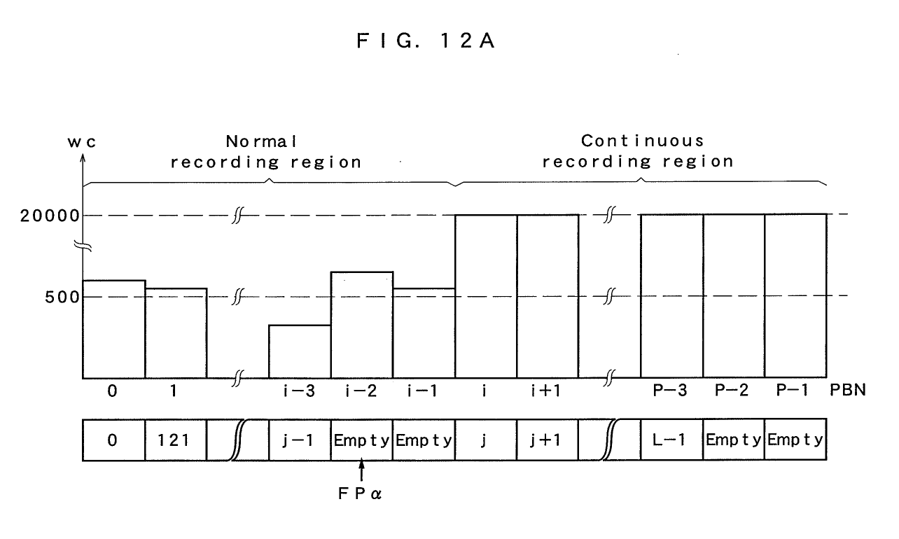

A recording procedure in the alternate manner in the normal recording mode carried out at S107 in FIG. 8 will be explained. FIG. 10 is a time chart showing data transmission from the access module 200 and data writing to the nonvolatile memory module 100. At first, a writing command, a LBN_S, a recording mode identification flag, and data of one logical block are sent from the access module 200 in sequence as shown in FIG. 10, and a series of data to an end command is subsequently sent. The LBN_S in the drawing is information showing a starting logical address, and shows a logical address corresponding to data of starting one logical block. Then, data is sent from the access module 200 in units of logical blocks. A logical address of data to be sent is determined by incrementing the logical address starting from the LBN_S in the reading-writing controller 127. Additionally, the recording mode identification flag takes value “0” indicating the normal recording mode.

Referring to FIG. 11, the writing processing in the alternate manner in the normal recording mode will be explained. FIG. 11 is a flowchart showing a procedure of the writing processing in the alternate manner. When writing data in the writing processing in the alternate manner, the reading-writing controller 127 detects the physical block PB which stores old data of the sent logical block as a block to be erased (S300). When the sent logical block number LBN is, for example, 0, a region storing old data of the logical block LB0, namely, the physical block PB0 with referring to the logical-physical conversion table 132 shown in FIG. 6.

Subsequently, the reading-writing controller 127 orders the address management part 125 to obtain an empty physical block to be a writing block of the sent data. The address management part 125 searches, in the region 110A, the physical block PB with the block status BS indicating 1 in an ascending order from the starting physical block PB0 in the physical region management table 131 shown in FIG. 5 (S301), and notifies the reading-writing controller 127 of the physical block PB (i-2) as a block to be written. Meanwhile, a starting position of searching the empty physical block, the search being carried out by the address management part 125, is set to the starting physical block PB0 in the region 110A in every initialization processing. After the initialization processing, the searching starts from the physical block PB detected by the previous search, and returns to the starting physical block PB0 after reaching the physical block PB (i-1) at the end of the region 110A. In the embodiment, since the empty pointer FPα is added to the detected empty physical block, the searching of next empty physical block starts from the physical block PB with the empty pointer FPα.

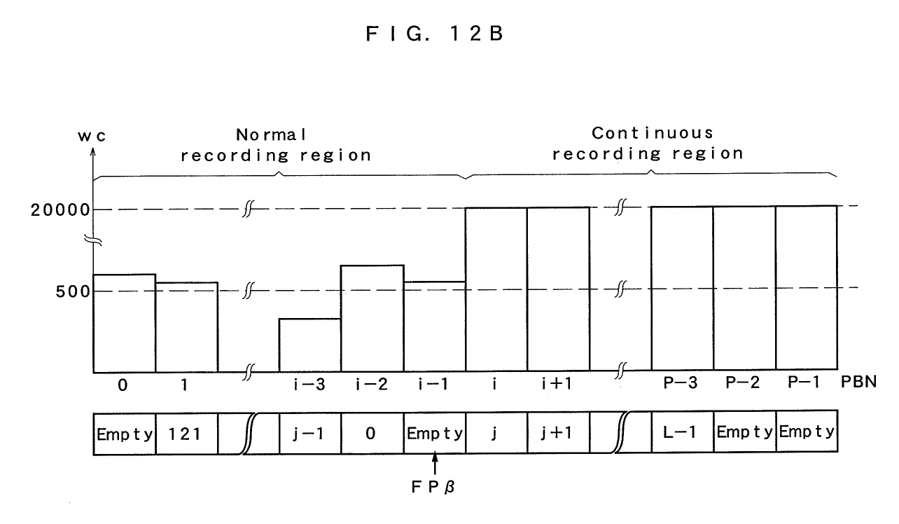

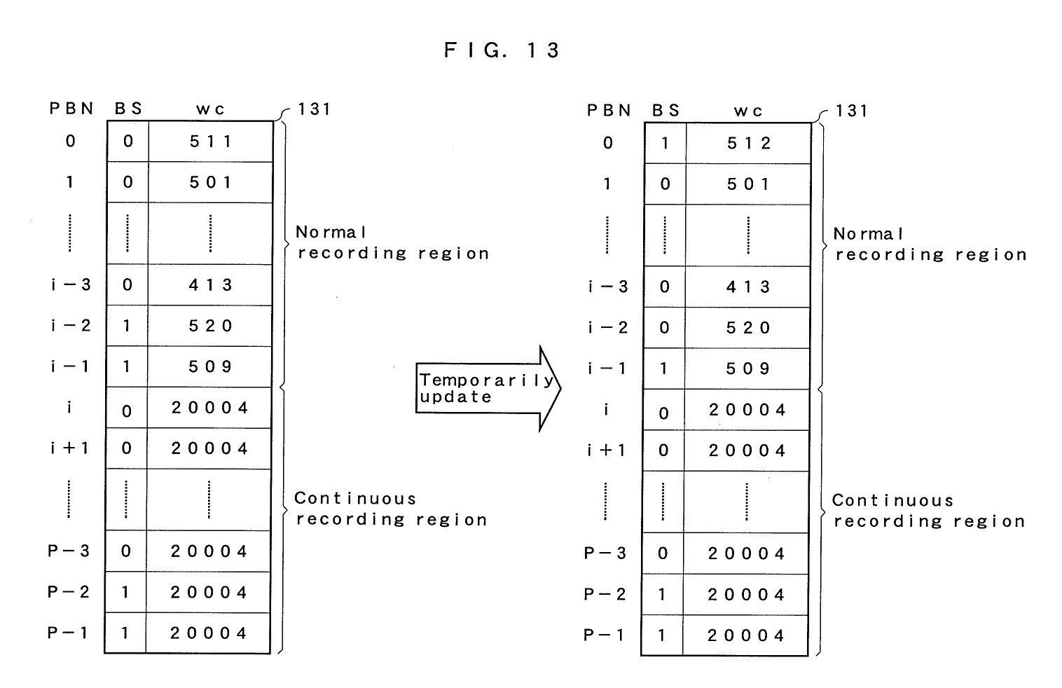

FIG. 12A and FIG. 12B show relationships of the logical block number LBN, the physical block number PBN, and the number of rewritings wc in the physical region management table 131 and the logical-physical conversion table 132 in this situation. FIG. 12A is an explanation view showing a relationship between information of the physical region management table 131 and information of the logical-physical conversion table 132 before the writing in the alternate manner. In FIG. 12A, a horizontal axis represents the physical block number PBN and a vertical axis represents the number of rewritings wc. Under the horizontal axis, the logical block LB corresponding to the physical block PB is shown.

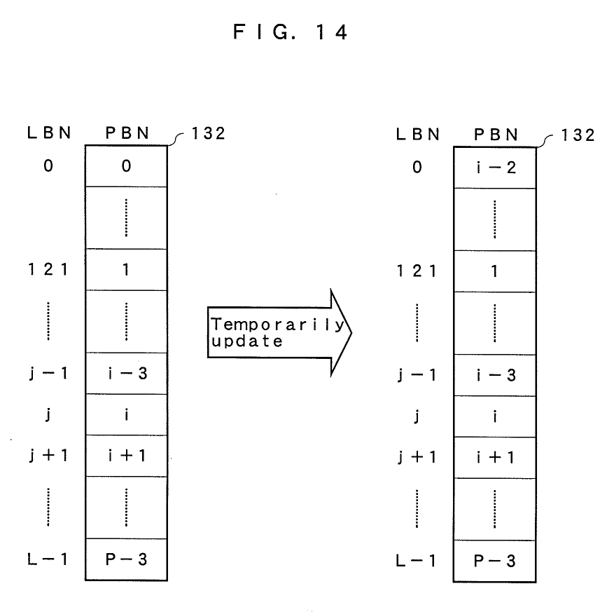

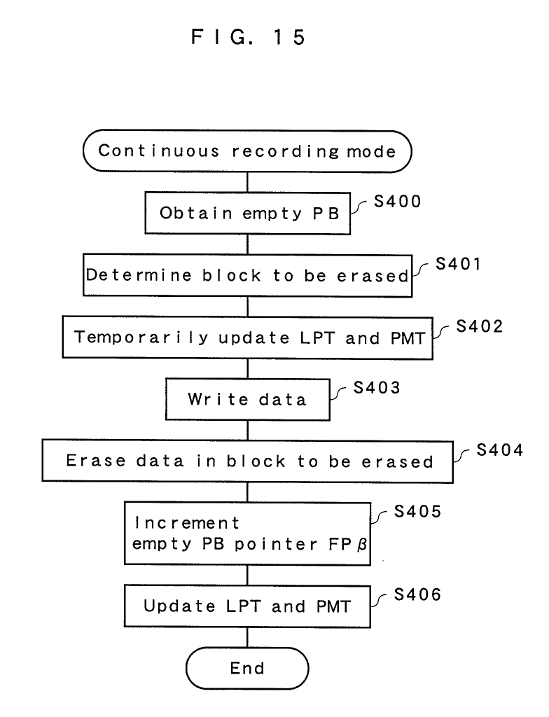

After that, as shown in a right side of FIG. 13, the physical region management table 131 is temporarily updated from a state of FIG. 5 so that the block status BS of the physical block PB0 in the physical region management table 131 can be 1 and the block status BS of the physical block PB(i-2) can be 0. In addition, since the number of rewritings of the physical block PB0 is increased by 1 because of processing for erasing old data at S304 described later, the number of rewritings wc of the physical block PB0 is temporarily updated from 511 to 512. Moreover, as shown in a right side of FIG. 14, the logical-physical conversion table 132 is temporarily updated from a state of FIG. 6 so that the physical block PB corresponding to the logical block LB0 can be changed from 0 to (i-2) (S302).

A relationship between the physical region management table 131 and logical-physical conversion table 132 after the temporal updating is shown in FIG. 12B. The physical block PB0 is turned to an empty block, and its number of rewritings wc is increased by 1. Additionally, the physical block PB (i-2) corresponds to the logical block LB0.

Then, the reading-writing controller 127 transfers a writing command for new data of the logical block LB0 and the physical block number (i-2) to be written to the memory interface 123. The memory interface 123 writes the new data of the logical block LB0 temporarily stored in the buffer 122 to the physical block PB(i-2) of the nonvolatile memory 110 (S303).

At the point of completion of writing new data at S303, the memory interface 123 erases old data of physical block PB0 storing the old data of the logical block LB0 under the control of the reading-writing controller 127 (S304). Meanwhile, in the erasing of the old data, the physical block storing the old data is already detected at S300.

After completion of processing up to S304, the reading-writing controller 127 in the memory controller 120 writes back the physical region management table 131 and the logical-physical conversion table 132 temporarily updated on the RAM in the address management part 125 to the management region of the nonvolatile memory 110 via the interface 123 (S305).

In the manner described above, the data writing of one logical block is completed. Following that, when the sent data is new data of one logical block, the processing returns from S108 to S107 in FIG. 8 and the writing processing in the alternate manner is carried out by repeating the above-mentioned procedure. When data subsequently sent is the end command, the writing processing in the alternate manner finishes.

### [Recording in the Continuous Recording Mode]

The data recording in the continuous recording mode carried out at S109 in FIG. 8 will be explained. In the continuous recording mode in the embodiment, TV programs are continuously recorded to the region 110B of the nonvolatile memory 110 without setting termination time of the recording. The access module 200 allocates recording data on the consecutive logical address space of the logical blocks LBj to LB(L-1) in the order of the logical block number. After allocating the recording data up to the last logical block LB(L-1), the logical blocks LBj to LB(L-1) are circularly used by returning to the starting logical block LBj and allocating subsequent recording data. That is, in the writing to the nonvolatile memory module 100, the recording data are sent from the start of the continuous recording to an end of the continuous recording.

Though, it is not required necessarily to allocate the recording data to the consecutive logical addresses of the logical blocks LBj to LB(L-1), and data of the continuous recording and data of the normal recording may randomly exist on the logical space. However, in that case, empty clusters sometimes cannot be continued to be scattered. When the host writes data to a card in such condition, the host sometimes cannot write the data in one writing command. On this occasion, the access module issues the writing command in each logical block and time overhead is caused by the issuance of the writing commands, thereby complicating the writing processing.

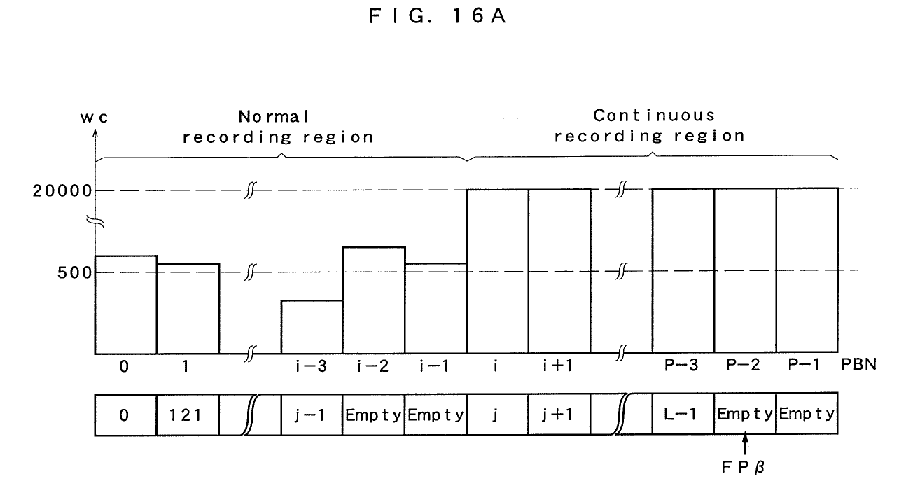

FIG. 15 is a flowchart showing a procedure of the writing processing in a circular manner in the continuous recording mode. When data shown in FIG. 10 is received from the access module 200 and the recording mode is determined as the continuous recording mode at S105 in FIG. 8, the reading-writing controller 127 orders the address management part 125 to obtain an empty physical block to be written. At this point, referring to the physical region management table 131 in FIG. 5, the address management part 125 notifies the reading-writing controller 127 of the physical block PB (P-2) indicated by the circular pointer FPβ indicating a starting position of the writing as the block to be written, and the reading-writing controller 127 obtains an empty physical block (S400). Moreover, the reading-writing controller 127 determines a physical block PB, the physical block tracking back by the number x of physical blocks from the obtained empty physical block, on the basis of following expression (5);

PB to be erased=FPβ−x (5),

and the reading-writing controller 127 determines the physical block to be erased (S401).

Since the region 110B includes not only the x physical blocks but also two spare physical blocks, the block to be erased is the physical block PBi when the circular pointer FPβ indicates the physical block (P-2). In this manner, two empty blocks, the physical block PBi and the physical block (P-1) erased when the circular pointer FPβ indicates the physical block (P-3), are ensured. Accordingly, two empty block are constantly ensured in the region 110B.

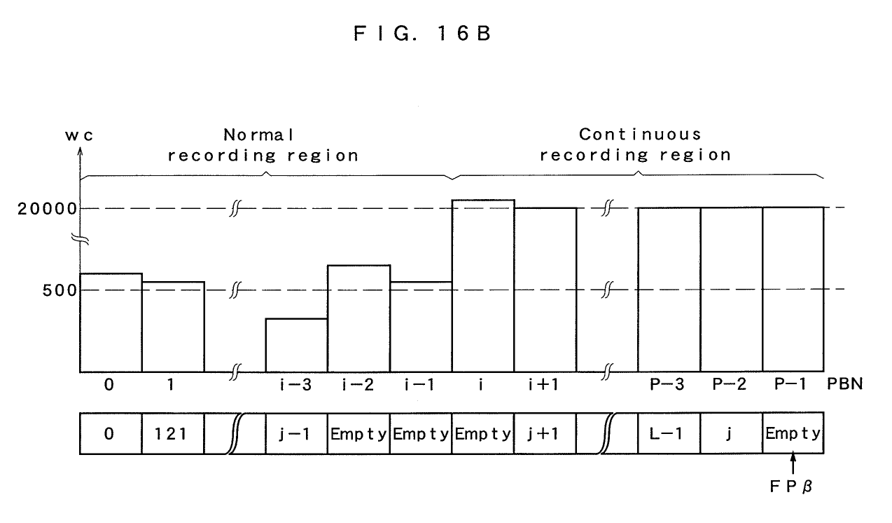

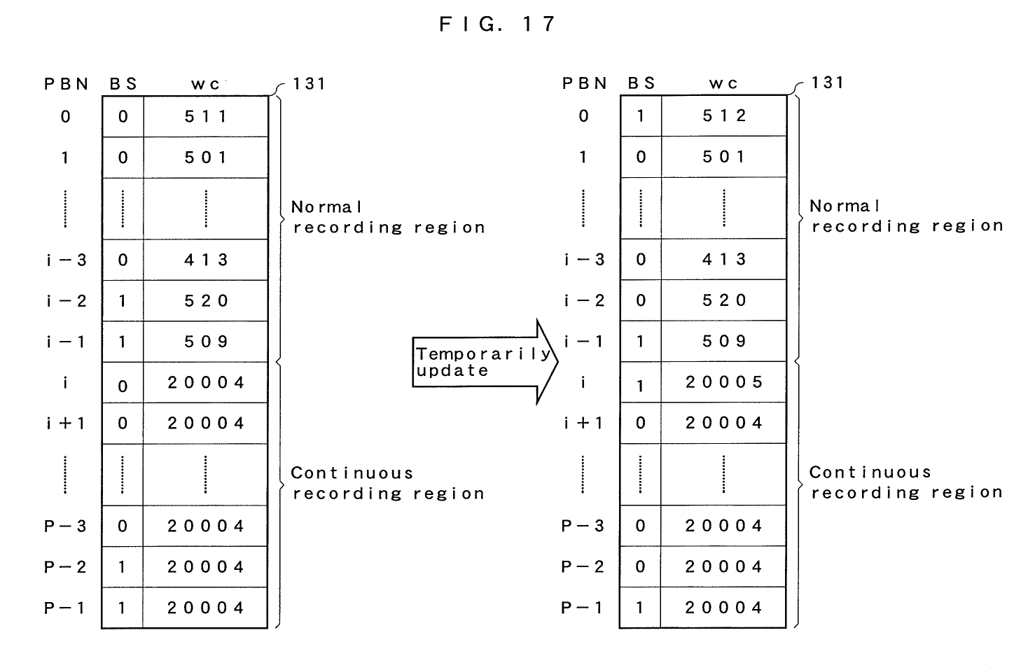

FIG. 16A and FIG. 16B show relationships of the logical block number LBN, the physical block number PBN, and the number of rewritings wc in the physical region management table 131 and the logical-physical conversion table 132 in this situation. In the drawing, the horizontal axis represents the physical block number PBN and the vertical axis represents the number of rewritings wc. Under the horizontal axis, the logical block number LBN corresponding to the physical block number PBN is shown in accordance with the logical-physical conversion table 132 in FIG. 6. In addition, the number of rewritings wc is shown in a bar graph in units of physical blocks in accordance with the physical region management table 131 in FIG. 5.

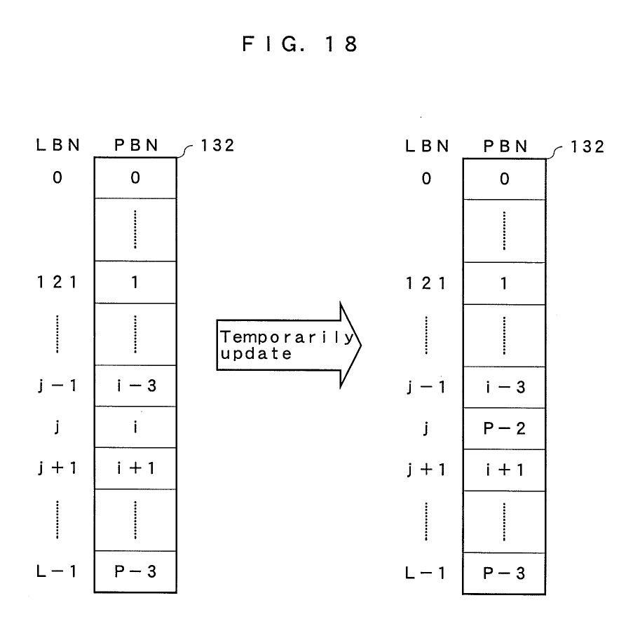

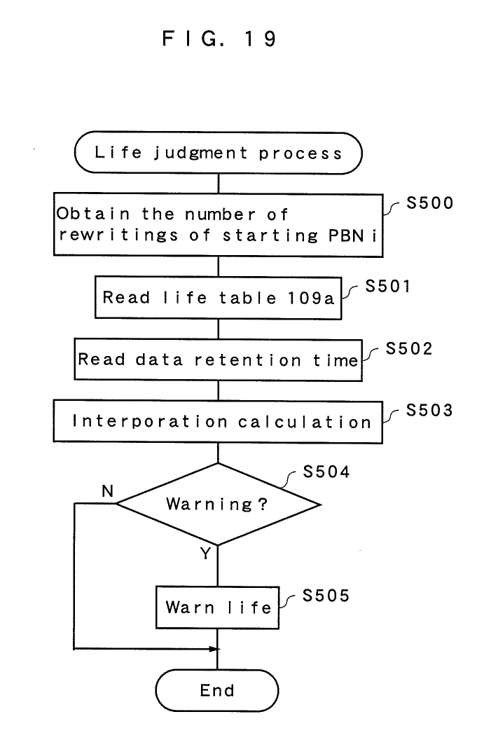

After that, as shown in a right side of FIG. 17, the physical region management table 131 is temporarily updated from a state of FIG. 5 so that the block status BS of the physical block PBi can be 1 and the block status BS of the physical block PB (P-2) can be 0. In addition, since the number of rewritings of the physical block PBi is increased by 1 because of the erasing of the physical block PBi, the number of rewritings wc of the physical block PBi is temporarily updated from 20004 to 20005. Moreover, as shown in a right side of FIG. 18, the logical-physical conversion table 132 is temporarily updated from a state of FIG. 6 so that the physical block PB corresponding to the logical block LBj can be changed from i to (P-2) (S402).

FIG. 16B shows a relationship between the physical region management table 131 and the logical-physical conversion table 132 after the temporal updating. The physical block PBi is turned to an empty block, and its number of rewritings wc is increased by 1. Additionally, the physical block PB (P-2) corresponds to the logical block LBj.

Then, the reading-writing controller 127 transfers a data writing command and the physical block number PBN to be written, namely, the physical block number PBN (P-2) to the memory interface 123. The memory interface 123 writes data temporarily stored to the buffer 122 to the physical block PB (P-2) of the nonvolatile memory 110 (S403). Then, the reading-writing controller 127 erases the data of physical block PBi determined at S401 (S404). After that, the reading-writing controller 127 increments the circular pointer FPβ and the circular pointer FPβ indicates the physical block number PB (P-1) (S405). The physical region management table 131 and the logical-physical conversion table 132 temporarily updated on the RAM in the address management part 125 are written back to the management region of the nonvolatile memory 110 (S406).

In the manner described above, the data writing of one logical block is completed, and a recording state of the nonvolatile memory 110 is changed from FIG. 16A to FIG. 16B. Following that, the writing of next logical block is carried out by the same procedure.

### [Life Determination Processing]

Referring to FIG. 7 and FIG. 19, the life determination processing carried out at S106 in FIG. 8, the processing being one of processing other than the writing, will be explained. FIG. 19 is a flowchart showing a procedure of the life determination processing.

When receiving the life request command from the access module 200, the CPU part 124 determines at S104 in FIG. 8 that the command is other than the writing command, and the life determination part 129 carries out the life determination processing. To obtain the number of rewritings wβ of the region 110B, the life determination part 129 firstly reads the number of rewritings wc of the starting physical block PBi of the region 110B from the physical region management table 131 and sets the number to the number of rewritings wβ (S500). The life determination part 129 reads the life table 129a shown in FIG. 7 from the internal ROM (S501). The life determination part 129 specifies two values of the number of rewritings wc, the values being first-closest and second-closest to the wβ, in the number of rewritings wc retained by the life table 129a, and sets one value of the number of rewritings wc smaller than the number of rewritings wβ to be the number of rewritings w1 and the other value of the number of rewritings wc larger than the number of rewritings wβ to be the number of rewritings w2. Subsequently, the data retention times r(w1) and r(w2) corresponding to the numbers of rewritings w1 and w2 are read, respectively (S502). Meanwhile, a dimension of the data retention time r is time. Then, an interpolation calculation is carried out in accordance with following expression (6) (S503);

r(wβ)=r(w1)+α{r(w2)−r(w1)} (6)

where α=(wβ−w1)/(w2−w1).
For example, in a case where the number of rewritings wβ is 180, since the number of rewritings w1 is 100 and the number of rewritings w2 is 200, the data retention time r(wβ) derived from expression (6) is 193762.

It is judged whether a warning is necessary or not on the basis of the value of r(wβ) that is the calculation result of expression (6) (S504). When the data retention time r(wβ) is less than 1, that is, the data retention time falls below 1 hour set as the maximum rewind time, it is determined that the warning is necessary, and the warning information is notified to the access module 200 via the host interface 121 (S505). When receiving the notification of the warning information, the warning information display 203 of the access device 200 displays the warning. Not only in the case where the data retention time falls below the maximum rewind time but also in a case where the data retention time r(wβ) becomes closer to the maximum rewind time to some extent, the warning information may be notified.

In the embodiment, the nonvolatile memory module 100 notifies the access module 200 of the life information in accordance with the life request command from the access module 200, however, the nonvolatile memory module 100 may notify the access module 200 of the life information with appropriately interrupting the access module without receiving the life request command. In addition, the life information is the warning information in the region 110B, however, warning information in the region 110A may be generated by carrying out the same processing. Moreover, instead of the warning information, it may be realized to calculate an estimated life on the basis of the data retention time r(wβ) and notify the estimated life. Furthermore, after receiving the warning information, the access module 200 may reset the maximum rewind time to be shorter than 1 hour to extend the life of the nonvolatile memory module 100.

### [Rewind Reproduction (Reading of Data Recorded in the Continuous Recording Mode)]

In the rewind reproduction, by addressing the starting logical block number LBN_S in accordance with the reading command from the access device 200 as an argument of the command and further addressing the recording mode identification flag to a value “1” indication the continuous recording mode, the rewind reproduction is carried out. On this occasion, since length of the rewind time can be calculated on the basis of the starting logical block number LBN_S and the recording rate, the access module 200 may calculate the starting logical block number LBN_S corresponding to desired length of the rewind time to send the starting logical block number LBN_S to the nonvolatile memory module 100. The data reading in the rewind reproduction is also carried out by the same manner for reading data recorded by the normal recording and can be easily realized by using a conventional commonly-known technique, and thus description thereof is omitted.

As described above, the nonvolatile memory system of the embodiment can divide the recording region of the nonvolatile memory 110 on the basis of the respective recording modes, and further can determine a writing manner and a size of the recording region appropriately on the basis of a recording condition, for example, required data retention time.

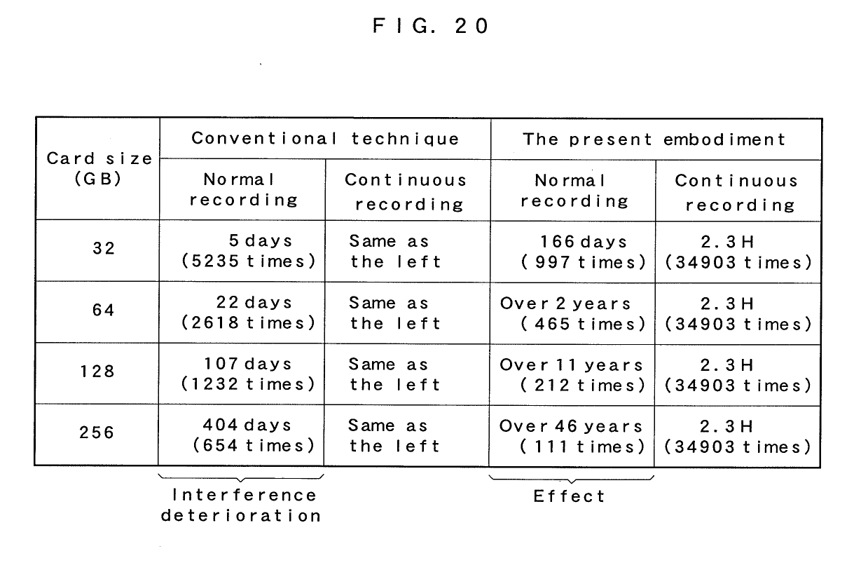

Meanwhile, when the maximum rewind time is 1 hour as described in the embodiment and the size of the region 110B is a little less than 4 Gbytes as described above, the data retention time after 10 years from first use of the nonvolatile memory module 100 under following use conditions is as shown in a right side in FIG. 20.

### <Use Conditions>

The normal recording time is 2 hours a day.

The continuous recording time (a watching time) is 10 hours a day.

The recording rate is 8.5 Mbps.

The rewind reproduction time is 1 hour. FIG. 20 shows comparison between the nonvolatile memory system according to the embodiment of the present invention and a conventional nonvolatile memory system regarding the data retention time in a case where both of the normal recording and the continuous recording are carried out under the above-mentioned use conditions. Numeral values in the parentheses show the number of rewritings after 10 years from first use of the nonvolatile memory module 100. According to FIG. 20, since the size of the region 110B is approximately 4 Gbytes regardless of a card capacity, the nonvolatile memory system of the embodiment ensures, for example, 166 days as the data retention time for the normal recording with ensuring 2.3 hours longer than the maximum rewind time of 1 hour as the retention time of data recorded in the continuous recording mode when the card capacity is 32 GB. However, the conventional nonvolatile memory system can ensure the retention time of only 5 days in both of the normal recording and the continuous recording. As described above, the nonvolatile memory system according to the embodiment can ensure the data retention time by approximately 30 times for the normal recording in comparison with the conventional nonvolatile memory system.

Meanwhile, though the recording mode is switched based on the recording mode identification flag in the embodiment, the recording mode may be switched based on the LBN_S sent by the access module 200. However, in that case, the nonvolatile memory module 100 is required to preliminarily know the relationship between the logical address and the recording mode. For example, the nonvolatile memory module has to know the starting logical block number of the region 110B.

In addition, though the embodiment with no bad block has been described, handlings (1) and (2) described below have to be carried out in a case where a bad block is generated. In the case of considering the bad block, the number of spare blocks is determined on the basis of a probability of generation of a defect in the nonvolatile memory 110.

Handling (1) A Case where a Block becomes a Bad Block in the Region 110A

As the conventional manner, the physical region management table 111 manages the bad block. That is, a block status BS of the bad block is set to the value “2” indicating a bad block to prevent the bad block from being used hereafter.

Handling (2) A Case where a Block becomes a Bad Block in the Region 110B

In addition to the above-described handling to the region 110A, in the increment of the circular pointer FPβ, an increment width is adjusted with constantly referring to the BS to avoid the bad block. Further in the calculation of the physical block number PBN to be erased in expression (5), the number PBN is determined with considering the number of the bad blocks, for example, adding the number of the bad blocks to that of physical block PBx.

The text of Japanese Patent Application No. 2007-310099 filed on Nov. 30, 2007 is hereby incorporated by reference.

What is claimed is:

1. A memory controller which is connected to a nonvolatile memory, and writes a first type of data required to be retained for long time and a second type of data not required to be retained for the long time and reads the written data in accordance with an access command from an outside, comprising:
an address management part for managing said nonvolatile memory by dividing the nonvolatile memory into a first region to which said first type of data is written and a second region to which second type of data is written; and
a reading-writing controller for writing only said first type of data to said first region in an alternate manner and writing only said second type of data to said second region in a circular manner.

2. The memory controller according to claim 1, further comprising:
a recording mode switch for determining a recording mode in accordance with recording mode identification information addressed by an outside, wherein
said reading-writing controller judges whether data to be written to said nonvolatile memory is said first type of data or said second type of data in accordance with the recording mode determined by said recording mode switch.

3. The memory controller according to claim 2, wherein
said recording mode identification information is configured by at least one of an address and a flag of a logical block to which data is written.

4. The memory controller according to claim 1, further comprising:
a recording region size setting part for determining a size of said second region on the basis of one of maximum rewind time information preliminarily set and addressed from an outside.

5. The memory controller according to claim 1, further comprising:
a life determination part for calculating at least data retention time of data stored in said second region, and for outputting warning information to an outside at one of timings when the data retention time falls below reproduction time corresponding to said maximum rewind time information and when the falling can be predicted.

6. A nonvolatile memory module which reads and writes data in accordance with an access command from an outside, wherein:
said nonvolatile memory module comprises:
a nonvolatile memory; and
a memory controller which is connected to a nonvolatile memory, and writes a first type of data required to be retained for long time and a second type of data not required to be retained for the long time and reads the written data in accordance with an access command from an outside; and
said memory controller includes:
an address management part for managing said nonvolatile memory by dividing the nonvolatile memory into a first region to which said first type of data is written and a second region to which second type of data is written; and
a reading-writing controller for writing only said first type of data to said first region in an alternate manner and writing only said second type of data to said second region in a circular manner.

7. The nonvolatile memory module according to claim 6, wherein
said memory controller further comprises:
a recording mode switch for determining a recording mode in accordance with recording mode identification information addressed by an outside, wherein
said reading-writing controller judges whether data to be written to said nonvolatile memory is said first type of data or said second type of data in accordance with the recording mode determined by said recording mode switch.

8. The nonvolatile memory module according to claim 7, wherein
said recording mode identification information is configured by at least one of an address and a flag of a logical block to which data is written.

9. The nonvolatile memory module according to claim 6, wherein
said memory controller further comprises:
a recording region size setting part for determining a size of said second region on the basis of one of maximum rewind time information preliminarily set and addressed from an outside.

10. The nonvolatile memory module according to claim 6, wherein
said memory controller further comprises:
a life determination part for calculating at least data retention time of data stored in said second region, and for outputting warning information to an outside at one of timings when the data retention time falls below reproduction time corresponding to said maximum rewind time information and when the falling can be predicted.

11. An access module connected to the nonvolatile memory module according to claim 7 to read and write data, comprising:
a recording mode notification part for notifying said nonvolatile memory module of said recording mode.

12. An access module connected to the nonvolatile memory module according to claim 9 to read and write data, comprising:
a recording mode notification part for notifying said nonvolatile memory module of said maximum rewind time information.

13. An access module connected to the nonvolatile memory module according to claim 10 to read and write data, comprising:
a warning information display for displaying said warning information received from said nonvolatile memory module.

14. A nonvolatile memory system comprising: an access module; and a nonvolatile memory module for reading and writing data in accordance with an access command from said access module, wherein:
said nonvolatile memory module includes:
a nonvolatile memory; and
a memory controller which is connected to a nonvolatile memory, and writes a first type of data required to be retained for long time and a second type of data not required to be retained for the long time and reads the written data in accordance with an access command from said access module; and
said memory controller includes:
an address management part for managing said nonvolatile memory by dividing the nonvolatile memory into a first region to which said first type of data is written and a second region to which second type of data is written; and
a reading-writing controller for writing only said first type of data to said first region in an alternate manner and writing only said second type of data to said second region in a circular manner.

15. The nonvolatile memory system according to claim 14, wherein
said memory controller further comprises:
a recording mode switch for determining a recording mode in accordance with recording mode identification information addressed by said access module, wherein
said reading-writing controller judges whether data to be written to said nonvolatile memory is said first type of data or said second type of data in accordance with the recording mode determined by said recording mode switch.

16. The nonvolatile memory system according to claim 15, wherein
said recording mode identification information is configured by at least one of an address and a flag of a logical block to which data is written.

17. The nonvolatile memory system according to claim 14, wherein
said memory controller further comprises:
a recording region size setting part for determining a size of said second region on the basis of one of maximum rewind time information preliminarily set and addressed from said access module.

18. The nonvolatile memory system according to claim 14, wherein
said memory controller further comprises:
a life determination part for calculating at least data retention time of data stored in said second region, and for outputting warning information to said access module at one of timings when the data retention time falls below reproduction time corresponding to said maximum rewind time information and when the falling can be predicted.
